(19) United States
(12) Patent Application Publication
(10) Pub. No.: US 2018/0023668 A1
(43) Pub. Date: Jan. 25, 2018

(54) PANEL DRIVING DEVICE AND HELIOSTAT

(71) Applicant: NABTESCO CORPORATION, Tokyo (JP)

(72) Inventors: Shingo MIWA, Mie (JP); Toshiharu HIBINO, Tokyo (JP); Shinji INOUE, Mie (JP); Motohiro TANAKA, Mie (JP)

(21) Appl. No.: 15/546,863

(22) PCT Filed: Jan. 21, 2016
(86) PCT No.: PCT/JP2016/051677

§ 371 Date: Jul. 27, 2017

(30) Foreign Application Priority Data
Jan. 30, 2015 (JP) 2015-016989

(51) Int. Cl. F16H 1/32; F24J 2/38; H02S 20/32; F16H 21/16

(52) U.S. Cl. CPC F16H 1/32; F16H 21/16; F24J 2/38; H02S 20/32

(57) ABSTRACT

A panel driving device rotates a panel structure to vary a tilt thereof or turns the panel structure about a vertical axis, the panel structure including a panel for receiving sunlight, the panel driving device including: a drive source including a rotational portion capable of rotating; and a transmission mechanism including a connection portion connected to the panel structure, and configured to convert a rotational movement of the rotational portion into rotation or turning of the panel structure without converting the rotational movement of the rotational portion into a linear movement, wherein the connection portion is offset from a rotation axis of the rotational portion.

### TECHNICAL FIELD

The present invention relates to a panel driving device for rotating or turning a panel structure including a panel for receiving the sunlight, and a heliostat including the panel driving device.

### BACKGROUND

There have been conventionally known panel driving devices used in solar thermal power generation facilities and photovoltaic power generation facilities. The panel driving devices serve to rotate or turn a panel to adjust the orientation of the panel for receiving the sunlight with respect to the sun. One example of such panel driving devices is disclosed in Patent Literature 1.

The invention disclosed in Patent Literature 1 is a panel driving device for a photovoltaic power generation apparatus that includes a tilt gear transmission unit for rotating the panel about a horizontal axis and a turn gear transmission unit for turning the panel about a vertical axis.

The turn gear transmission unit is mounted on an upper end of an erected support column. The tilt gear transmission unit is mounted on the turn gear transmission unit. The photovoltaic power generation apparatus includes a pair of panels arranged on opposite sides of the support column. In addition, a pair of shafts are arranged on opposite sides of the tilt gear transmission unit so as to extend in the horizontal direction coaxially with each other. The pair of shafts are connected to the tilt gear transmission unit arranged therebetween. Each of the shafts is connected to associated one of the panels. The tilt gear transmission unit rotates the shafts about the respective axes. Thus, each of the panels rotates about the axis of the associated shaft so as to vary the tilt thereof.

In the constitution of the panel driving device disclosed in Patent Literature 1, the shafts supporting the panels undergo a bending moment caused by the weight of the panels and the wind blowing the panels. The bending moment is imparted directly to the tilt gear transmission unit for rotating the shafts about the respective axes. The invention disclosed in Patent Literature 2 is a panel driving device constructed so as to overcome such a problem.

As an example of a panel driving device in a photovoltaic power generation apparatus, Patent Literature 2 discloses a tracking drive unit for adjusting an orientation of a solar cell panel in accordance with the movement of the sun. The tracking drive unit includes a mechanism for adjusting the tilt of the solar cell panel by rotating the solar cell panel about a tilt rotation axis in the horizontal direction in accordance with the height of the sun, and a worm reducer for adjusting the turning angle of the solar cell panel by turning the solar cell panel about the turning rotation axis in the vertical direction in accordance with the angle of direction of the sun.

The worm reducer is provided on an upper end of a support column erected on the ground. The solar cell panel is mounted on the worm reducer so as to be capable of rotating about the tile rotation axis. The mechanism for adjusting the tilt of the solar cell panel includes a power cylinder as a drive unit. The power cylinder is mounted on the worm reducer in a tilted position. The distal end of the power cylinder is connected to a back surface of the solar cell panel. As the power cylinder expands or contracts, the solar cell panel rotates about the tilt rotation axis, and thus the tilt of the solar cell panel is adjusted.

In the constitution of tracking drive unit of Patent Literature 2, the power cylinder as a drive unit is offset from the tilt rotation axis. Therefore, even when a bending moment occurs in the tilt rotation axis due to the weight of the solar cell panel or the wind blowing the solar cell panel, the bending moment can be prevented from being imparted directly to the power cylinder.

However, in a panel driving device including a direct-acting drive unit such as a power cylinder, the drive unit has a large length in the direction of direct-acting thereof. That is, the power cylinder has a large length in the direction of expansion and contraction thereof. As a result, there is a problem that the size of the device is large.

### RELEVANT REFERENCES

### PATENT LITERATURE

Japanese Patent Application Publication No. 2010-48337

Japanese Patent Application Publication No. 2007-19331

### SUMMARY

One object of the present invention is to prevent a bending moment from being imparted directly to a drive source of a panel driving device for rotating or turning a panel structure including a panel for receiving the sunlight, and to downsize the panel driving device.

A panel driving device according to one aspect of the present invention is a panel driving device for rotating a panel structure to vary a tilt thereof or turning the panel structure about a vertical axis, the panel structure including a panel for receiving sunlight, the panel driving device comprising: a drive source including a rotational portion capable of rotating; and a transmission mechanism including a connection portion connected to the panel structure, and configured to convert a rotational movement of the rotational portion into rotation or turning of the panel structure without converting the rotational movement of the rotational portion into a linear movement, wherein the connection portion is offset from a rotation axis of the rotational portion.

A heliostat according to another aspect of the present invention comprises: a support column erected at a desired place; a panel structure having a panel made of a mirror receiving and reflecting sunlight and supported at an upper end of the support column; and the panel driving device.

### BRIEF DESCRIPTION OF THE DRAWINGS

FIG. 1 is a perspective view of a light receiving apparatus including a panel driving device according to an embodiment of the present invention.

FIG. 2 is a side view of the light receiving apparatus shown in FIG. 1.

FIG. 3 is a sectional view of the panel driving device along the axial direction thereof.

FIG. 4 is a sectional view of the panel driving device along the IV-IV line in FIG. 3.

FIG. 5 schematically shows a link mechanism of a transmission mechanism of the panel driving device.

FIG. 6 is a perspective view of a light receiving apparatus including a panel driving device according to a first variation of the present invention.

FIG. 7 is a side view of the light receiving apparatus according to the first variation shown in FIG. 6.

FIG. 8 is a plan view of the light receiving apparatus according to the first variation shown in FIG. 6, as viewed from the back side of the panel.

FIG. 9 is a perspective view of a light receiving apparatus including a panel driving device according to a second variation of the present invention.

FIG. 10 is a side view of a light receiving apparatus including a panel driving device according to a third variation of the present invention.

FIG. 11 is a sectional view of a panel driving device according to a variation of the embodiment shown in FIG. 1, as viewed along the axial direction thereof.

FIG. 12 is a perspective view of a light receiving apparatus including a panel driving device according to another variation of the embodiment shown in FIG. 1.

FIG. 13 is a side view of the light receiving apparatus shown in FIG. 12.

FIG. 14 is a plan view of a light receiving apparatus according to another variation of the present invention, as viewed from the back side of the panel.

### DESCRIPTION OF EXAMPLE EMBODIMENTS

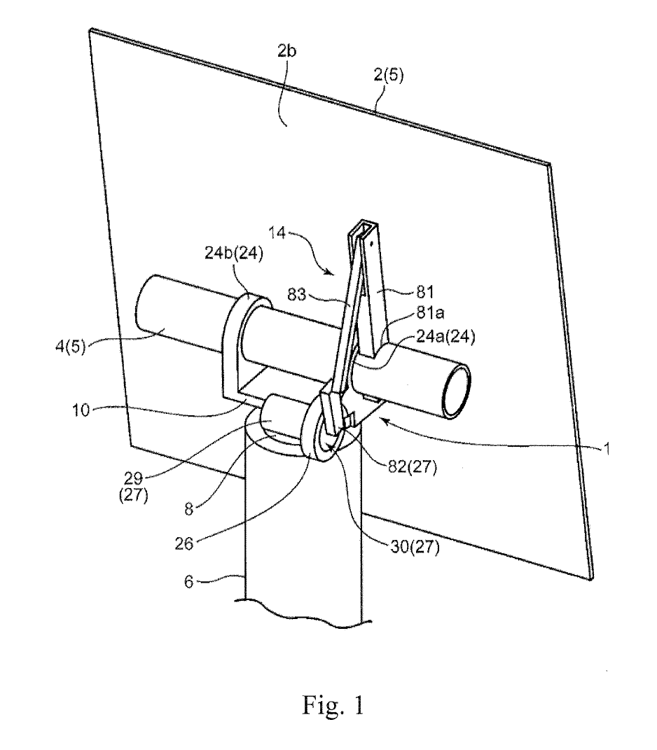

A light receiving apparatus 100 including a panel driving device 1 according to an embodiment of the present invention will now be described with reference to FIGS. 1 to 5.

The light receiving apparatus 100 may be used in solar thermal power generation facilities or photovoltaic power generation facilities. A solar thermal power generation facility may include a tower, one or more light receiving apparatuses 100, and a power generator. The tower may include a light collecting unit in the upper portion thereof. The one or more light receiving apparatuses 100 may track the movement of the sun and reflect the sunlight toward the light collecting unit of the tower. The power generator may generate power using the heat of the light collected at the light collecting unit of the tower. The light receiving apparatuses 100 used in the solar thermal power generation facility are so-called heliostats. The one or more light receiving apparatuses 100 serving as heliostats may be disposed away from and around the tower and reflect the sunlight toward the light collecting unit so as to collect the sunlight at the light collecting unit of the tower. The light receiving apparatus 100 used in a photovoltaic power generation facility may include solar cells that convert the received sunlight into electric energy for power generation.

As shown in FIG. 1, the light receiving apparatus 100 may include a panel structure 5, a panel driving device 1, a support column 6, and a turn driving device 8.

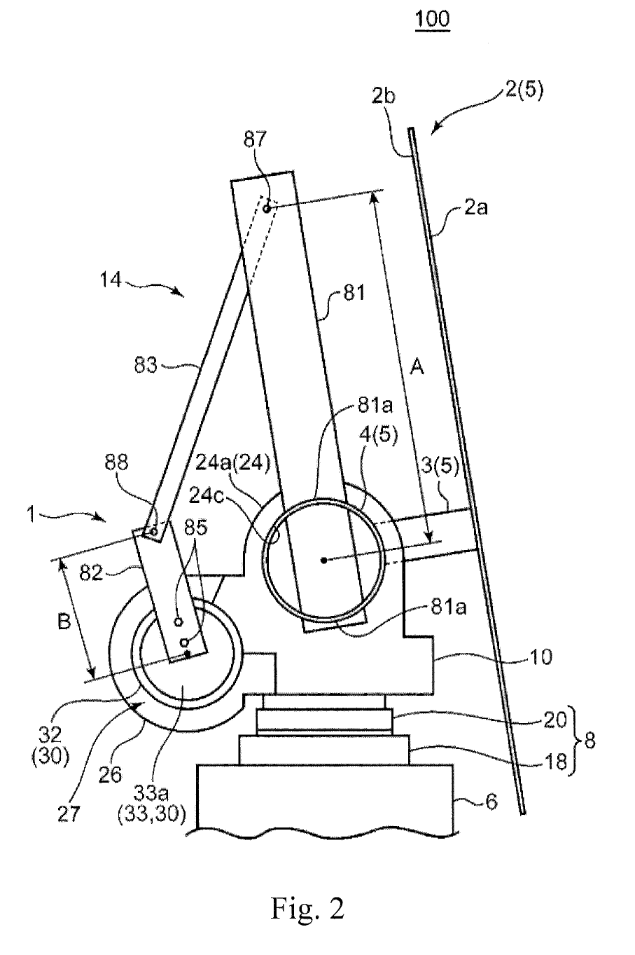

The panel structure 5 may include a panel 2, a fixed portion 3 (see FIG. 2), and a support shaft 4.

The panel 2 may receive the sunlight. The panel 2 may include a light incident surface 2a (see FIG. 2) on which the sunlight is to be incident and a back surface 2b on the opposite side to the light incident surface 2a. In the light receiving apparatus 100 as a heliostat used in solar thermal power generation facilities, the panel 2 includes a mirror for reflecting the received sunlight toward the light collecting unit of the tower. The light incident surface 2a may correspond to a reflection surface of the mirror reflecting the sunlight. In the light receiving apparatus 100 used in photovoltaic power generation facilities, the panel 2 includes a solar cell panel including arrays of a large number of solar cells for converting the sunlight incident on the light incident surface 2a into electric energy.

The fixed portion 3 (see FIG. 2) may be linked to the back surface 2b of the panel 2 so as to project from the back surface 2b. The opposite end of the fixed portion 3 to the panel 2 may be linked to the support shaft 4. That is, the support shaft 4 may be attached to the back surface 2b of the panel 2 via the fixed portion 3.

The support shaft 4 may have a cylindrical shape. The support shaft 4 may extend horizontally so as to be separate from the back surface 2b of the panel 2 and parallel with the panel 2. The support shaft 4 may support the panel 2 via the fixed portion 3. In the embodiment, the support shaft 4 may serve as a rotation shaft of the panel 2. The panel structure 5 including the panel 2 as a whole may rotate about the axis of the support shaft 4, that is, a horizontal axis.

The support column 6 may be erected on the ground so as to extend vertically. The turn driving device 8 may be provided on the upper end portion of the support column 6.

The turn driving device 8 may cause the panel driving device 1 and the panel structure 5 to turn about the vertical axis thereby to adjust the orientation of the panel 2 about the vertical axis with respect to the sun. As shown in FIG. 2, the turn driving device 8 may include a turn driving unit 18 and a turned portion 20.

The turn driving unit 18 may be fixed on the support column 6 with the most part thereof housed in the upper end portion of the support column 6. The upper end of the turn driving unit 18 may be projected beyond the upper end of the support column 6.

The turned portion 20 may be projected upward from the upper end of the turn driving unit 18. The turned portion 20 may be supported by the turn driving unit 18 so as to be capable of turning about the vertical axis thereof that corresponds to the axis of the support column 6. The turned portion 20 may be turned about the vertical axis thereof by the drive force produced by the turn driving unit 18. The turning of the turned portion 20 caused by the turn driving unit 18 may cause the panel driving device 1, a support base 10, and the panel structure 5 supported by the support base 10 to turn about the vertical axis integrally with the turned portion 20.

In the embodiment, the panel driving device 1 may cause the panel structure 5 to rotate about the axis of the support shaft 4. More specifically, the panel driving device 1 may cause the panel structure 5 to rotate about the axis of the support shaft 4 thereby to adjust the orientation of the panel 2 about the horizontal axis with respect to the sun. In other words, the panel driving device 1 may rotate the panel structure 5 to vary the tilt of the panel structure 5 about the horizontal axis. The structure of the panel driving device 1 will be hereinafter described in detail.

As shown in FIGS. 1 and 2, the panel driving device 1 may include the support base 10, a drive source 27, and a transmission mechanism 14.

The support base 10 may support the panel structure 5 such that the panel structure 5 can rotate about the axis of the support shaft 4. That is, the support base 10 may support the panel structure 5 so as to enable rotation of the panel structure 5 that varies the tilt of the panel 2. The support base 10 may be fixed on the turned portion 20. The support base 10 may be capable of turning about the vertical axis corresponding to the axis of the support column 6 integrally with the turned portion 20. The support base 10 may include a pair of shaft support portions 24 that support the support shaft 4.

The pair of shaft support portions 24 may include a first shaft support portion 24a and a second shaft support portion 24b. The first and second shaft support portions 24a, 24b may be positioned away from each other in the axial direction of the support shaft 4 extending horizontally. Each of the shaft support portions 24 may have a through-hole 24c formed therein (see FIG. 2). The support shaft 4 may be inserted through the through-holes 24c. The support shaft 4 may be retained on the inner peripheral surfaces of the through-holes 24c so as to be rotatable about the axis of the support shaft 4.

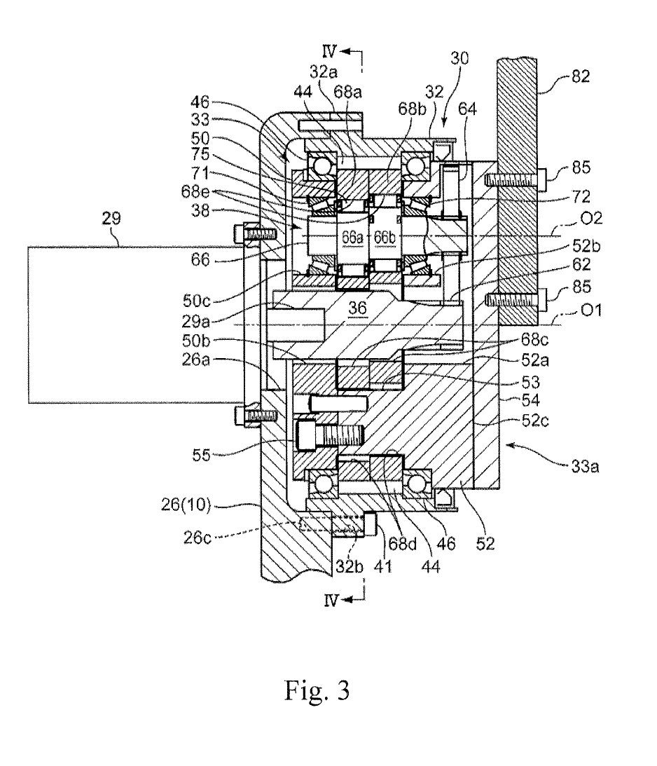

The support base 10 may include a support portion 26 that supports the drive source 27 of the panel driving device 1. More specifically, the support portion 26 may support a motor 29 and a speed reducer 30 (described later) of the drive source 27. The support portion 26 may be positioned near the first shaft support portion 24a. The support portion 26 may be projected from the first shaft support portion 24a along a horizontal direction that is perpendicular to the axial direction of the support shaft 4, As shown in FIG. 3, the support portion 26 may have an insertion hole 26a formed therein.

The drive source 27 may include an electric motor 29 (hereinafter referred to simply as the motor 29), the speed reducer 30, and a drive-side rotational portion 82 that can rotate.

As shown in FIG. 1, the motor 29 and the speed reducer 30 may be arranged in the direction corresponding to the axial direction of the support shaft 4. The motor 29 may be positioned closer to the second shaft support portion 24b than is the support portion 26. The motor 29 may produce a drive force for rotating the drive-side rotational portion 82. The motor 29 may include a drive shaft 29a to be rotated. The motor 29 may be fixed on the support portion 26 with the drive shaft 29a inserted through the insertion hole 26a (see FIG. 3).

The speed reducer 30 may reduce the rotation speed of the drive shaft 29a of the motor 29 and rotate the drive-side rotational portion 82 at the reduced rotation speed. In the embodiment, the speed reducer 30 may be an eccentric oscillating speed reducer. The speed reducer 30 may use the drive force of the motor 29 to produce a rotational drive force for rotating the panel structure 5 including the panel 2 about the horizontal axis. As shown in FIGS. 1 and 2, the speed reducer 30 may be offset from the support shaft 4 in the radially outward direction of the support shaft 4. More specifically, the speed reducer 30 may be positioned away from the support shaft 4 in the direction perpendicular to the axial direction of the support shaft 4. In this position, the speed reducer 30 may reduce the rotation speed of the drive shaft 29a of the motor 29 at a predetermined ratio and rotate a carrier 33 at the reduced rotation speed. The speed reducer 30 may rotate the carrier 33 offset from the support shaft 4 that serves as a rotation shaft of the panel 2.

The speed reducer 30 may be positioned on the opposite side to the motor 29 with respect to the support portion 26 and may be fixed on the support portion 26. As shown in FIG. 3, the speed reducer 30 may include a casing 32, the carrier 33, an input shaft 36, and a reduction mechanism 38.

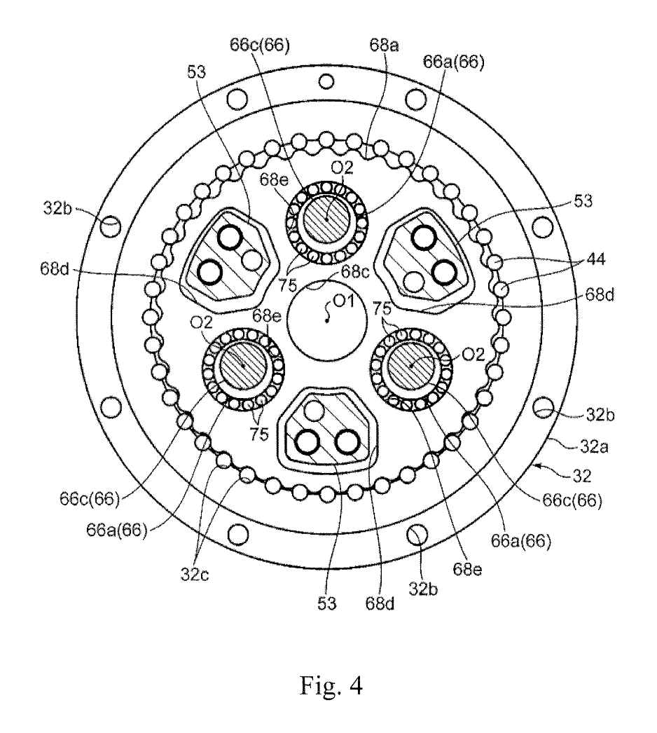

The casing 32 may have a substantially cylindrical shape. In the inner peripheral surface of the casing 32, there may be formed a large number of pin grooves 32 (see FIG. 4). The large number of pin grooves may be arranged at constant intervals in the circumferential direction of the inner peripheral surface of the casing 32. The pin grooves 32c may have a pin-shaped internal teeth 44 fitted therein. That is, a large number of pin-shaped internal teeth 44 fitted in a large number of pin grooves 32c may form an internal gear. The casing 32 may be positioned such that the axial direction thereof corresponds to the axial direction of the support shaft 4 (see FIGS. 1 and 2), that is, the casing 32 may be in parallel with the support shaft 4.

In the outer peripheral portion of the casing 32, there may be integrally provided a flange portion 32a (see FIGS. 3 and 4). The flange portion 32a may have a plurality of bolt insertion holes 32b arranged at constant intervals in the circumferential direction. As shown in FIG. 3, bolts 41 may be inserted into the bolt insertion holes 32b and screwed into associated screw holes 26c in the support portion 26, so as to fasten the casing 32 on the support portion 26.

The carrier 33 may have a substantially cylindrical column shape. The carrier 33 may be supported in the casing 32 so as to be rotatable coaxially with the casing 32. More specifically, the carrier 33 may be supported by the casing 32 via a pair of primary bearings 46 positioned at a distance from each other in the axial direction of the casing 32. Thus, the carrier 33 may be rotatable coaxially with the casing 32. That is, the carrier 33 may be rotatable about the axis O1 of the casing 32 relative to the casing 32. The carrier 33 may be positioned such that the axial direction thereof corresponds to the axial direction of the support shaft 4. That is, the axis of the carrier 33 may extend in parallel with the axis of the support shaft 4. In addition, the carrier 33 may be positioned coaxially with the drive shaft 29a of the motor 29. That is, the axial direction of the carrier 33 may correspond to the axial direction of the drive shaft 29a of the motor 29, and thus the axis of the carrier 33 may correspond to the drive shaft 29a.

The carrier 33 may include an end plate portion 50, a base plate portion 52, a plurality of shaft portions 53, and a cover portion 54.

The end plate portion 50 may have a disc shape. The end plate portion 50 may be positioned on one axial end side of the casing 32, being closer to the support portion 26. The end plate portion 50 may have formed therein a through-hole 50b that extends through the middle of the end plate portion 50 in the axial direction of the carrier 33. In addition, the end plate portion 50 may have formed therein a plurality of through-holes 50c. These through-holes 50c may be positioned around the through-hole 50b in the middle and arranged at constant intervals in the circumferential direction of the through-hole 50b.

The base plate portion 52 may be positioned on the other axial end side of the casing 32, being opposite to the support portion 26. The base plate portion 52 may have formed therein a through-hole 52a that extends through the middle of the base plate portion 52 in the axial direction of the carrier 33. In addition, the base plate portion 52 may have formed therein a plurality of through-holes 521). These through-holes 52b may be positioned around the through-hole 52a in the middle and arranged at constant intervals in the circumferential direction of the through-hole 52a. The through-hole 52a in the middle and the plurality of through-holes 52b may be continuous to each other in an end surface 52c of the base plate portion 52 on the opposite side to the end plate portion 50, thereby forming one space.

The plurality of shaft portions 53 may be provided on a surface of the base plate portion 52 on the end plate portion 50 side. The plurality of shaft portions 53 may extend from the surface of the base plate portion 52 on which they are provided, toward the end plate portion 50. The plurality of shaft portions 53 may be arranged at constant intervals in the circumferential direction of the carrier 33. Each of the shaft portions 53 may be fastened to the end plate portion 50 by a bolt 55 with distal end surface of the shaft portions 53 contacting the end plate portion 50. There may be a space having a predetermined width in the axial direction between the base plate portion 52 and the end plate portion 50.

The cover portion 54 may have a disc shape. The cover portion 54 may be mounted on the base plate portion 52 so as to cover the end surface 52c of the base plate portion 52 on the opposite side to the end plate portion 50.

The carrier 33 may have a projecting portion 33a projecting outward of the casing 32 in the direction of the axis (the rotation axis) of the carrier 33. The projecting portion 33a may include the cover portion 54 and an end portion of the base plate portion 52 on the cover portion 54 side. That is, the cover portion 54 and an end portion of the base plate portion 52 on the cover portion 54 side may project outward of an end portion of the casing 32 on the opposite side to the support portion 26 in the direction of the axis of the carrier 33.

The drive-side rotational portion 82 may be an example of a rotational portion of the drive source in the present invention. The drive-side rotational portion 82 may rotate integrally with the carrier 33 and may be connected to the transmission mechanism 14. The drive-side rotational portion 82 may be connected (fixed) to the projecting portion 33a of the carrier 33, so as to be rotatable about the axis of the carrier 33 integrally with the carrier 33. The drive-side rotational portion 82 may extend from the projecting portion 33a radially outward of the casing 32 at a position on the side where the projecting portion 33a of the carrier 33 projects from the casing 32. The drive-side rotational portion 82 may be fixed to the cover portion 54 corresponding to an end portion of the carrier 33 projecting from an end portion of the casing 32 on the opposite side to the support portion 26. The drive-side rotational portion 82 may be fastened to the cover portion 54 with bolts 85 (see FIG. 3).

The proximal end portion of the input shaft 36 may be connected to the drive shaft 29a of the motor 29, such that the input shaft 36 may be coaxial with the drive shaft 29a. The distal end portion of the input shaft 36 may be positioned in the through-hole 52a of the base plate portion 52. On the distal end portion of the input shaft 36, there may be integrally provided a drive gear 62 constituted by an external gear.

The reduction mechanism 38 may include a plurality of transmission gears 64, a plurality of crankshafts 66, a first oscillating gear 68a, and a second oscillating gear 68b.

The transmission gears 64 may be positioned in the space formed of the through-hole 52a in the middle and the plurality of through-holes 52b continuous to each other, and more specifically, at positions associated with the through-holes 52b. Each of the transmission gears 64 may be connected to an end portion of the associated crankshaft 66 on the base plate portion 52 side. The transmission gears 64 may mesh with the drive gear 62. Accordingly, the rotation of the drive shaft 29a of the motor 29 may be transmitted to the crankshafts 66 via the input shaft 36, the drive gear 62, and the associated transmission gears 64, and thus the crankshafts 66 may rotate.

The crankshafts 66 may be arranged in parallel with the input shaft 36. The crankshafts 66 may be inserted through the associated through-holes 50c in the end plate portion 50 and the associated through-holes 52b in the base plate portion 52. Further, the crankshafts 66 may be supported by the end plate portion 50 via first crank bearings 71 provided in the through-holes 50c and supported by the base plate portion 52 via second crank bearings 72 provided in the through-holes 52b. Thus, the crankshafts 66 may be rotatable.

Each of the crankshafts 66 may include a shaft body 66c (see FIG. 4), and a first eccentric portion 66a and a second eccentric portion 66b formed integrally with the shaft body 66c.

The first and second eccentric portions 66a, 66b may be eccentric with respect to a crankshaft axis O2 corresponding to the axis of the shaft body 66c. The first eccentric portion 66a and the second eccentric portion 66b may be mutually out of phase. That is, the direction of eccentricity of the first eccentric portion 66a with respect to the crankshaft axis O2 may be different from the direction of eccentricity of the second eccentric portion 66b with respect to the crankshaft axis O2. Further, the direction of eccentricity of the first eccentric portion 66a may be the same for all the crankshafts 66, and the direction of eccentricity of the second eccentric portion 66b may be the same for all the crankshafts 66. The first and second eccentric portions 66a, 66b may be positioned adjacent to each other in the axial direction between the first crank bearing 71 and the second crank bearing 72. The first eccentric portion 66a may be adjacent to the first crank bearing 71, and the second eccentric portion 66b may be adjacent to the second crank bearing 72.

The first and second oscillating gears 68a, 68b may be positioned in a space between the base plate portion 52 and the end plate portion 50. The first and second oscillating gears 68a, 68b may be one example of external gears of the present invention. Each of the oscillating gears 68a, 68b may have a first through-hole 68c into which the input shaft 36 may be inserted, a second through-hole 68d into which the shaft portion 53 may be inserted, and a plurality of third through-holes 68e into which the eccentric portions 66a, 66b of the crankshafts 66 may be inserted Each of the oscillating gears 68a, 68b may have external teeth that mesh with the internal teeth 44. The external teeth of the oscillating gears 68a, 68b may be shaped with smooth wavy curves. Further, the number of external teeth of the oscillating gears 68a, 68b may be slightly smaller than the number of internal gears 44. Thus, while the external teeth and the internal teeth 44 mesh with each other without backlash, the oscillating gears 68a, 68b oscillate and rotate gradually. The speed reducer 30 may be configured to reduce the rotation speed of the drive shaft 29a of the motor 29 in accordance with the difference between the number of internal teeth 44 provided on the inner periphery of the casing 32 and the number of external teeth of the first oscillating gear 68a and the difference between the number of internal teeth 44 provided on the inner periphery of the casing 32 and the number of external teeth of the second oscillating gear 68b.

Each of the first and second eccentric portions 66a, 66b may have a straight roller bearing 75 mounted thereto. The first eccentric portions 66a may be inserted through the third through-holes 68e of the first oscillating gear 68a, and the second eccentric portions 66b may be inserted through the third through-holes 68e of the second oscillating gear 68b. That is, the first oscillating gear 68a may engage with the first eccentric portions 66a via the associated straight roller bearings 75, and the second oscillating gear 68b may engage with the second eccentric portions 66b via the associated straight roller bearings 75. As the crankshafts 66 rotate to cause the first and second eccentric portions 66a, 66b to rotate eccentrically, the first and second oscillating gears 68a, 68b may rotate and oscillate eccentrically, while meshing with the plurality of internal teeth 44 on the inner periphery of the casing 32.

The transmission mechanism 14 (see FIG. 2) may convert the rotational movement of the drive-side rotational portion 82 into rotation of the panel structure 5 about the axis of the support shaft 4 without converting it into a linear movement. The transmission mechanism 14 may transmit the rotational movement of the drive-side rotational portion 82 to the support shaft 4.

The transmission mechanism 14 may be a link mechanism including a connection link member 81, a transmission link member 83, a first link pin 87, a second link pin 88, a first bearing (not shown) that receives the first link pin 87, and a second bearing (not shown) that receives the second link pin 88. The connection link member 81 may be an example of a panel-side rotational portion in the present invention. The transmission link member 83 may be an example of a transmitting portion in the present invention.

The connection link member 81 may extend linearly. The connection link member 81 may be fixed to the support shaft 4 so as to extend in the radial direction of the support shaft 4. The connection link member 81 may protrude from the outer peripheral surface of the support shaft 4 and extend radially outward. The connection link member 81 may be fixed to the support shaft 4 at a position opposite to the second shaft support portion 24b with respect to the first shaft support portion 24a and adjacent to the first shaft support portion 24a. The connection link member 81 may be rotatable around the axis of the support shaft 4 integrally with the support shaft 4 of the panel structure 5.

The connection link member 81 may include a connection portion 81a connected to the support shaft 4 of the panel structure 5. The connection portion 81a may be offset from the rotation axis of the drive-side rotational portion 82, that is, offset from the rotation axis of the carrier 33. The connection portion 81a may be offset from the entire speed reducer 30 and the carrier 33. The support shaft 4 may have formed therein a hole through which the connection link member 81 is inserted in the radial direction of the support shaft 4. In a state in which the connection link member 81 is inserted into the hole, the peripheral edge portion of the hole in the support shaft 4 may be welded to the connection portion 81a of the connection link member 81. Thus, the connection portion 81a may be fixed to the support shaft 4.

The transmission link member 83 may transmit a rotational drive force between the connection link member 81 and the drive-side rotational portion 82. The transmission link member 83 may extend linearly. One end portion of the transmission link member 83 may be pin-coupled to the connection link member 81 by the first link pin 87, and the other end portion of the transmission link member 83 may be pin-coupled to the drive-side rotational portion 82 by the second link pin 88. The first bearing (not shown) may be interposed between the first link pin 87 and the end portion of the connection link member 81 or between the first link pin 87 and one end portion of the transmission link member 83. By means of the first bearing, the first link pin 87 may be supported so as to be rotatable about the axis thereof. The second bearing (not shown) may be interposed between the second link pin 88 and the end portion of the drive-side rotational portion 82 or between the second link pin 88 and the other end portion of the transmission link member 83. By means of the second bearing, the second link pin 88 may be supported so as to be rotatable about the axis thereof. The first bearing and the second bearing may be constituted by sealed bearings which can prevent the intrusion of fine foreign matter such as sand and dust.

The first and second link pins 87, 88 may be arranged so as to extend in parallel with the axis of the support shaft 4. The transmission link member 83 may be rotatable about the first link pin 87 relative to the connection link member 81 and may be rotatable about the second link pin 88 relative to the drive-side rotational portion 82.

The rotation radius A of the connection link member 81 may be larger than the rotation radius B of the drive-side rotational portion 82.

The rotation radius A of the connection link member 81 may correspond to the distance between the axis of the support shaft 4, which is the rotation center of the connection link member 81, and the first link pin 87. The rotation radius B of the drive-side rotational portion 82 may correspond to the distance between the axis of the carrier 33 (the axis of the casing 32), which is the rotation center of the drive-side rotational portion 82, and the second link pin 88.

The link mechanism of the transmission mechanism 14 may be configured to rotate the drive-side rotational portion 82 and the support shaft 4 in the same direction. Further, the link mechanism of the transmission mechanism 14 may rotate the support shaft 4 at a rotation angle corresponding to the ratio between the rotation radius A and the rotation radius 13 applied to the rotation angle of the drive-side rotational portion 82.

The panel driving device 1 configured as described above may perform the following operation.

First, the motor 29 may operate to rotate the drive shaft 29a. The rotation of the drive shaft 29a may be applied to the input shaft 36, whereby the input shaft 36 may rotate. As the input shaft 36 rotates, the transmission gears 64 may rotate via the drive gear 62, and the crankshafts 66 may rotate together with the transmission gears 64. When each crankshaft 66 rotates, the first oscillating gear 68a may rotate while meshing with the internal teeth 44 in accordance with the rotation of the first eccentric portion 66a, and the second oscillating gear 68b may rotate while meshing with the internal teeth 44 in accordance with the rotation of the second eccentric portion 66b. Thus, the carrier 33 may rotate relative to the casing 32. The rotation speed of the carrier 33 may be the rotation speed of the input shaft 36, or the rotation speed of the drive shaft 29a of the motor 29, decelerated at a predetermined ratio.

In this way, the rotational drive force may be generated by the motor 29 and the speed reducer 30. The generated rotational drive force may be transmitted from the drive-side rotational portion 82 to the support shaft 4 via the transmission mechanism 14.

More specifically, the drive-side rotational portion 82 may rotate about the axis of the carrier 33, and accordingly the drive-side rotational portion 82 may operate the transmission link member 83 via the second link pin 88. As a result, the transmission link member 83 may rotate the connection link member 81 around the axis of the support shaft 4 via the first link pin 87. As a result, the support shaft 4 rotates together with the connection link member 81 around the axis of the support shaft 4, and the entire panel structure 5 may rotate around the axis of the support shaft 4. Through such operation, the tilt of the panel 2 about the horizontal axis, that is, about the axis of the support shaft 4 may be adjusted.

As described above, the panel driving device 1 according to the present embodiment may include the transmission mechanism 14 that converts the rotational movement of the drive-side rotational portion 82 into the rotation of the panel structure 5. The connection portion 81a of the transmission mechanism 14 connected to the panel structure 5 may be offset from the rotation axis of the drive-side rotation portion 82. Therefore, even when a bending moment occurs in the support shaft 4 due to the weight of the panel 2 or the wind blowing the panel 2, the bending moment can be prevented from being imparted directly to the drive source 27.

Further, in the panel driving device 1 of the present embodiment, the transmission mechanism 14 may convert the rotational movement of the drive-side rotational portion 82 into the rotation of the panel structure 5 without converting it into a linear movement, and therefore, the panel driving device 1 of the present embodiment can be downsized as compared with the conventional panel driving device using a direct-acting drive source. More specifically, direct-acting cylinders, ball screws, and the like are conventionally known as direct-acting drive sources. With direct-acting cylinders, the dimension in the direction of expansion and contraction may be very large, and with ball screws, the dimension in the axial direction of the screw shaft may be very large. By contrast, the drive source 27 of the present embodiment as a whole may have a smaller size than the direct-acting drive source in the direction of direct-acting. Therefore, the panel driving device 1 can be downsized. As a result, it is possible to improve ease of transporting and assembling the panel driving device 1.

In the present embodiment, the rotation radius A of the connection link member 81 rotating integrally with the panel structure 5 may be larger than the rotation radius B of the drive-side rotational portion 82 rotating integrally with the carrier 33 of the speed reducer 30. Therefore, when the panel 2 receives the wind and a rotational moment occurs in the support shaft 4 about the axis thereof, the drive source 27 (the speed reducer 30) may undergo a smaller load via the transmission mechanism 14.

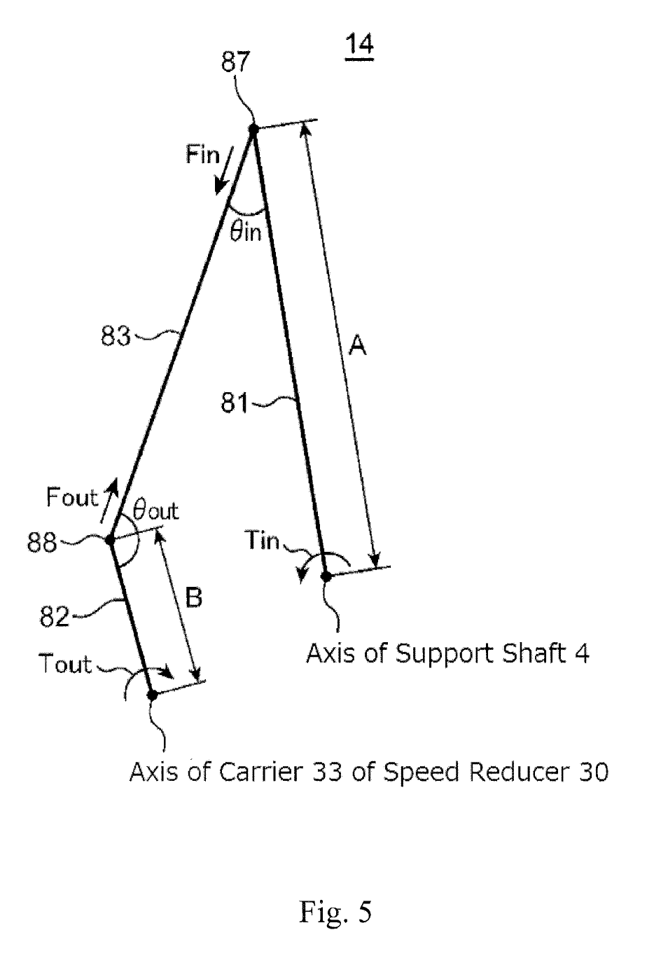

FIG. 5 schematically shows the configuration of the link mechanism of the transmission mechanism 14. The reason why the load imparted to the speed reducer 30 can be reduced will be described with reference to FIG. 5.

Suppose that a rotational moment occurs in the support shaft 4 as the panel 2 receives the wind, and as a result, a torque Tᵢₙ is imparted to the support shaft 4. The load torque imparted to the speed reducer 30, in other words, the torque that needs to be output from the carrier 33 is Tₒᵤₜ. Also, the force caused by the torque Tᵢₙ and imparted to the transmission link member 83 from the connection link member 81 via the first link pin 87 is Fᵢₙ. Further, the force caused by the torque Tₒᵤₜ and imparted to the transmission link member 83 from the drive-side rotational portion 82 via the second link pin 88 is Fₒᵤₜ.

The force Fᵢₙ is obtained by Formula (1), and the force Fₒᵤₜ is obtained by Formula (2).

Fᵢₙ=Tᵢₙ/Asinθᵢₙ Formula (1)

Fₒᵤₜ=Tₒᵤₜ/Bsinθₒᵤₜ Formula (2)

Since the force Fᵢₙ and the force Fₒᵤₜ are balanced in the transmission link member 83, Formula (3) holds.

Tᵢₙ/Asinθᵢₙ=Tₒᵤₜ/Asinθₒᵤₜ Formula (3)

Formula (4) is obtained from Formula (3).

Tₒᵤₜ=Bsinθₒᵤₜ/Asinθᵢₙ)×Tᵢₙ Formula (4)

It can be seen from Formula (4) that the torque Tout corresponding to the load applied to the speed reducer 30 decreases as the rotation radius A of the connection link member 81 is larger than the rotation radius B of the drive-side rotational portion 82. Therefore, in the present embodiment, it is possible to reduce the load applied to the speed reducer 30 via the transmission mechanism 14 and the drive-side rotational portion 82 when the panel 2 receives the wind and a rotational moment occurs in the support shaft 4.

Further, in the present embodiment, since the transmission mechanism 14 is a link mechanism, the burden of maintenance of the transmission mechanism 14 can be reduced. More specifically, for example, in a transmission mechanism that transmits a rotational drive force via a timing belt or a chain from the drive-side rotational portion of the drive source to a panel-side rotational portion provided on the support shaft, the timing belt or the chain may be stretched with operation time. For this reason, it is necessary to replace the timing belt or chain as maintenance of the transmission mechanism. For this reason, the burden of maintenance is large. By contrast, as for the link mechanism, the link pin and the bearings receiving the link pin may have design lives well balanced with that of the panel driving device 1, that is, design lives equal to or longer than that of the panel driving device 1. As a result, the link mechanism is almost maintenance-free. Therefore, the burden of maintenance can be reduced.

In addition, the transmission mechanism using the timing belt or the chain have to be shielded with a cover for protection in order to prevent fine foreign matters such as sand from intruding between the belt or the chain and the rotational portion and causing malfunction. By contrast, as for the link mechanism, since the bearing that receives the link pin is sealed, almost no malfunction occurs due to intrusion of fine foreign matter. Thus, shielding with the cover is unnecessary. Therefore, the configuration of the panel driving device 1 can be simple.

Further, in the present embodiment, the speed reducer 30 may be the eccentric oscillating speed reducer configured as described above. Therefore, it is possible to adjust the rotation angle of the panel 2 with high precision without backlash. More specifically, it is possible to adjust the tilt of the panel 2 with high precision. For example, in a panel driving device using a ball screw as a driving unit, backlash occurs due to the structure of the ball screw, and thus it is difficult to adjust the rotation angle of the panel with high precision. By contrast, as for the speed reducer 30, constituted by an eccentric oscillating speed reducer, backlash may be finer than in the ball screw, it is possible to adjust the rotation angle of the panel 2 with high precision. In particular, in a concentrating solar thermal power generation facility in which the panel 2 made of a mirror reflects the sunlight to collect it at the light collecting unit of the tower, it is important for increasing the power generation efficiency to adjust the orientation of the panel 2 accurately in accordance with the movement of the sun to collect the sunlight at the light collecting unit accurately. According to the panel driving device 1 of the present embodiment, the rotation angle of the panel 2 can be adjusted with high precision, it is possible to adjust the orientation of the panel 2 in accordance with the movement of the sun with high precision to accurately collect the sunlight at the light collecting unit of the tower, resulting in higher power generation efficiency.

In the present embodiment, the drive-side rotational portion 82 connected to the transmission mechanism 14 may extend in the radial direction of the casing 32 at the position on the side where the projecting portion 33a of the carrier 33 projects from the casing 32 and may be coupled to the projecting portion 33a. Therefore, it can be prevented that when the speed reducer 30 rotates the carrier 33 about the rotation axis thereof relative to the casing 32, the drive-side rotational portion 82 interferes with the casing 32 and the rotation range of the drive-side rotational portion 82 is restricted.

The embodiment disclosed above is a mere example in all respects, and the invention is not limited to this embodiment. The scope of the invention will be defined by the appended claims not by the above-described embodiment. It is intended to cover modifications and equivalent arrangements that are within the spirit and scope of the appended claims.

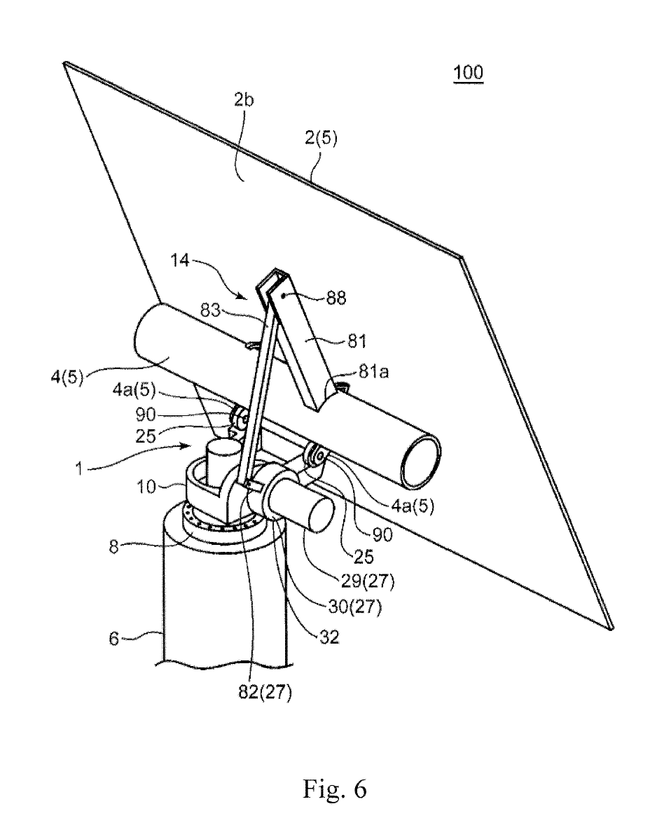

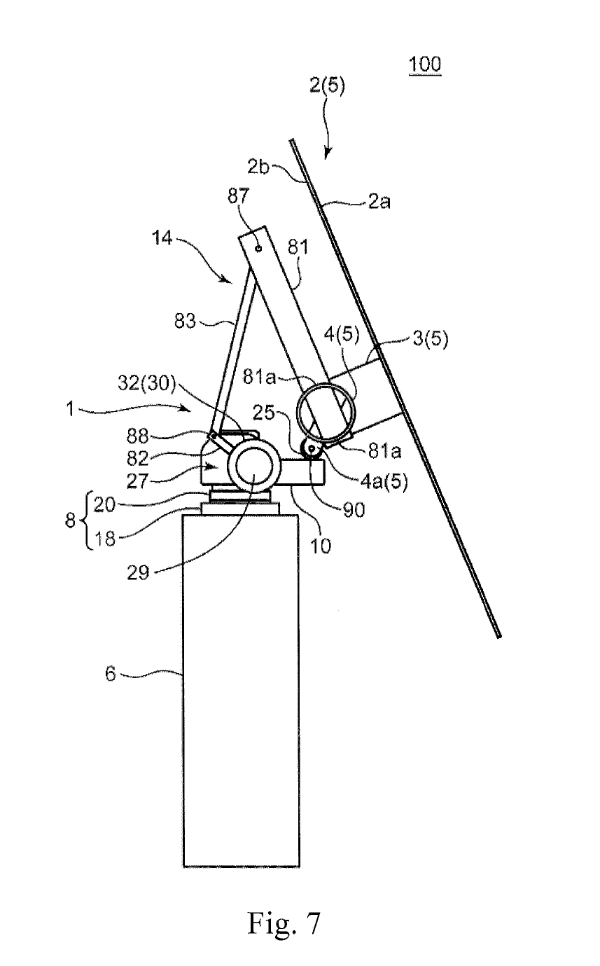

For example, as in the first variation of the present invention shown in FIGS. 6 to 8, the rotation axis of the panel 2, or the rotation axis of the panel structure 5 may be separate from that of the support shaft 4. That is, in the first variation, a shaft pin 90 may serve as the rotation axis of the panel 2.

More specifically, in the first variation, the panel structure 5 may include a pair of shaft engaging portions 4a projecting from the outer peripheral surface of the support shaft 4. The pair of shaft engaging portions 4a may be arranged at an interval in the axial direction of the support shaft 4. Further, the support base 10 may include a pair of shaft support portions 25. The pair of shaft support portions 25 may be arranged at an interval in the axial direction of the support shaft 4 so as to correspond to the pair of shaft engaging portions 4a.

Each of the shaft engaging portions 4a and the shaft support portions 25 may have a corresponding through-hole formed therein, One of the shaft engaging portions 4a and the associated one of the shaft support portions 25 may overlap each other as viewed from the axial direction of the support shaft 4, and may be coupled to each other via a shaft pin 90 inserted through the through-holes. Also, the other shaft engaging portion 4a and the associated shaft support portion 25 may be coupled to each other in the same manner. The shaft pin 90 coupling the shaft engaging portion 4a and the shaft support portion 25 may extend in the axial direction of the support shaft 4, that is, in the horizontal direction. The pair of shaft pins 9 may be arranged coaxially. The panel structure 5 may be rotatable about the axis of the pair of shaft pins 90 relative to the support base 10.

In the first variation, the speed reducer 30 may be offset from the support shaft 4 and also offset from the pair of shaft pins 90 serving as the rotation axis of the panel 2.

Further, in the first variation, the transmission mechanism 14 may be connected to the casing 32 of the speed reducer 30 via the drive-side rotational portion 82. More specifically, in the first variation, a carrier (not shown) of the speed reducer 30 may be fixed to one outer surface of the support base 10 in the axial direction of the shaft pin 90. The casing 32 and the carrier of the speed reducer 30 are arranged in such a position that the axial directions thereof correspond to the axial direction of the shaft pins 90. The casing 32 is configured to rotate about the axis of the casing 32 with respect to the carrier fixed to the support base 10. The rotation axis of the casing 32, that is, the rotation axis of the drive-side rotational portion 82 may be parallel to the axis of the shaft pins 9 which is the rotation axis of the panel structure 5. The drive-side rotational portion 82 may be coupled and fixed to the outer peripheral surface of the casing 32. The drive-side rotational portion 82 may extend from the outer peripheral surface of the casing 32 in the radially outward direction of the casing 32. Further, the motor 29 may be disposed on the opposite side to the support base 10 with respect to the speed reducer 30.

In the first variation, the rotational drive force generated in the speed reducer 30 may be outputted from the casing 32. That is, the casing 32 may rotate about the axis thereof with respect to the carrier, and the drive-side rotational portion 82 may rotate integrally with the casing 32 about the axis of the casing 32.

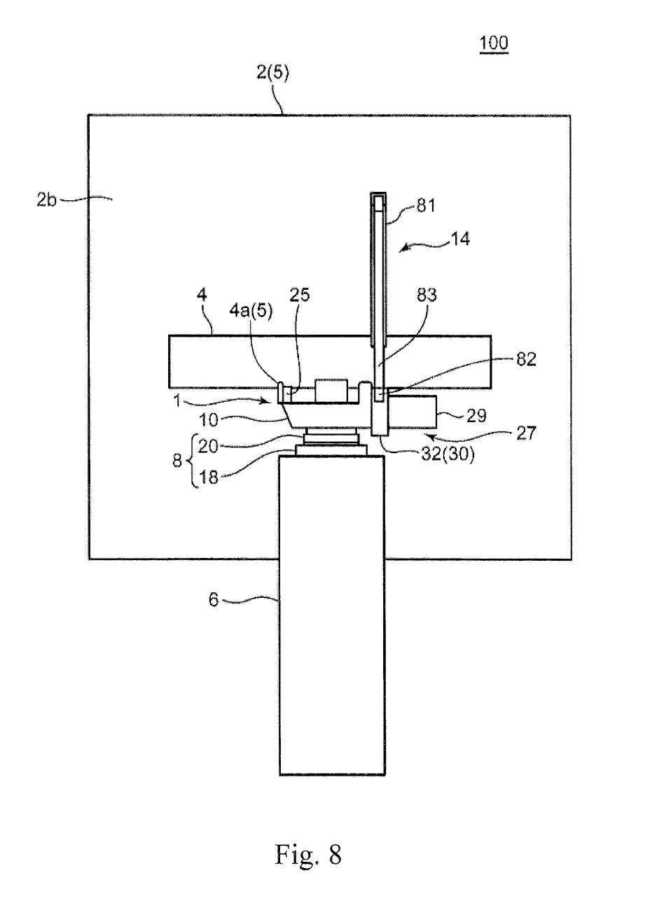

In the first variation, as shown in FIG. 8, the transmission mechanism 14 (the link mechanism) may be disposed within the range of the radial width of the support column 6, as viewed from a direction perpendicular to both the turning axis (the vertical axis) of the panel driving device 1 and the panel structure 5 corresponding to the axis of the support column 6 and the tilt axis (the rotation axis extending horizontally) of the panel structure 5.

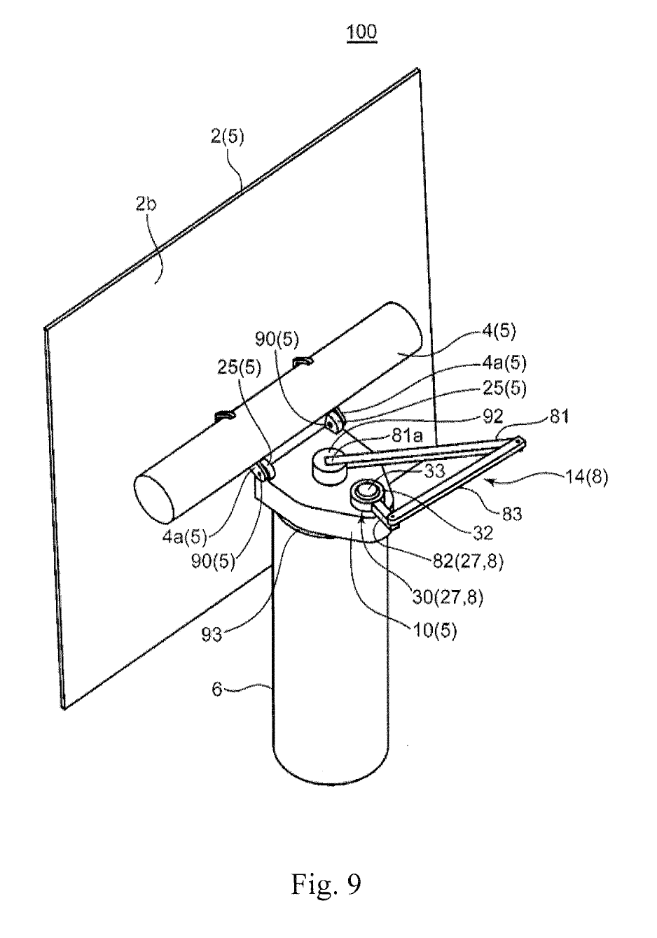

Further, the configuration of the panel driving device of the present invention may be applied to the turn driving device that turns the panel structure about the vertical axis thereof. FIG. 9 shows a light receiving apparatus 100 of a second variation as an example of such applications.

The light receiving apparatus 100 according to the second variation includes a panel structure 5, a support column 6, a base portion 93, and a turn driving device 8.

In the second variation, the panel structure 5 may include a panel 2, a support shaft 4, a pair of shaft engagement portions 4a, a pair of shaft support portions 25, a pair of shaft pins 90, a support base 10, and a shaft portion 92. The shaft portion 92 may project upward from the upper surface of the support base 10. The shaft portion 92 may be coaxial with the support column 6.

The base portion 93 may be fixed to the upper end of the support column 6. The support base 10 may be provided on the base portion 93. The base portion 93 may support the support base 10 of the panel structure 5 so as to be rotatable about the axis of the support column 6 extending vertically.

In the second variation, the turn driving device 8 may correspond to the panel driving device of the present invention. The turn driving device 8 may include a drive source 27 and a transmission mechanism 14.

The drive source 27 may include a motor (not shown), a speed reducer 30, and a drive-side rotational portion 82. The motor (not shown) and the speed reducer 30 may be provided on the support base 10.

The speed reducer 30 may be disposed such that the axial direction of the casing 32 and the carrier 33 corresponds to the axial direction of the support column 6. The carrier 33 may be fixed to the upper surface of the support base 10. The casing 32 may be provided coaxially with the carrier 33 so as to surround the outer periphery of the carrier 33. The casing 32 may be rotatable about the axis thereof with respect to the carrier 33. The drive-side rotational portion 82 may be coupled to the outer peripheral surface of the casing 32. The drive-side rotational portion 82 may extend from the outer peripheral surface of the casing 32 to which it is coupled, in the radially outward direction of the casing 32.

The connection portion 81a of the connection link member 81 of the transmission mechanism 14 may be coupled to the shaft portion 92. The connection portion 81a may be offset from the rotation axis of the drive-side rotational portion 82, that is, offset from the rotation axis of the casing 32. The connection link member 81 may extend from the outer peripheral surface of the shaft portion 92 in the radially outward direction of the shaft portion 92.

When the drive source 27 generates the rotational drive force, the casing 32 of the speed reducer 30 may rotate about the axis thereof with respect to the carrier 33. As a result, the drive-side rotational portion 82 may rotate together with the casing 32, and the rotation of the drive-side rotational portion 82 may be transmitted to the connection link member 81 via the transmission link member 83. Thus, the shaft portion 92 may rotate about the axis thereof, that is, about the axis of the support column 6, together with the connection link member 81. As a result, the panel structure 5 may turn about the axis of the support column 6.

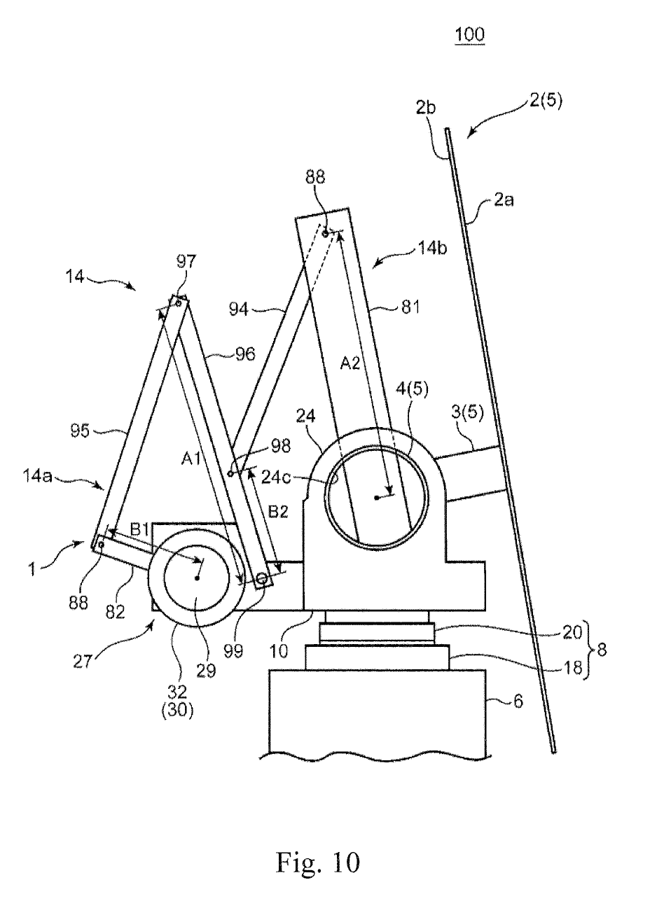

In addition, it may also be possible that the transmission mechanism includes a plurality of stages of link mechanisms in order to transmit the drive force between the rotational portion of the drive source and the panel structure. FIG. 10 shows a light receiving apparatus 100 having a panel driving device 1 according to a third variation that uses an example of such a transmission mechanism.

The transmission mechanism 14 in the third variation may be a link mechanism including the connection link member 81, a first transmission link member 94, a second transmission link member 95, a third transmission link member 96, the first link pin 87, the second link pin 88, a third link pin 97, a fourth link pin 98, and a support pin 99.

The connection link member 81 may be attached to the support shaft 4 of the panel structure 5.

One end of the first transmission link member 94 may be pin-coupled to the connection link member 81 by the first link pin 87. The first transmission link member 94 is rotatable about the first link pin 87 relative to the connection link member 81.

One end of the second transmission link member 95 may be pin-coupled to the drive-side rotational portion 82 by the second link pin 88. The second transmission link member 95 may be rotatable about the second link pin 88 relative to the drive-side rotational portion 82.

The third transmission link member 96 may be connected to the other end of the first transmission link member 94 and the other end of the second transmission link member 95. More specifically, one end of the third transmission link member 96 may be pin-coupled to the other end of the second transmission link member 95 by the third link pin 97, and a middle portion between the one end and the other end of the third transmission link member 96 may be pin-coupled to the other end of the first transmission link member 94 by the fourth link pin 98. As a result, the other end of the first transmission link member 94 can rotate about the fourth link pin 98 relative to the third transmission link member 96, and the other end of the second transmission link member 95 may be rotatable about the third link pin 97 relative to the third transmission link member 96.

The other end of the third transmission link member 96 may be supported by the support base 10 via the support pin 99. The third transmission link member 96 may be rotatable about the support pin 99.

The link mechanism 14a at the first stage may be constituted by the second link pin 88, the second transmission link member 95, the third link pin 97, the third transmission link member 96, and the support pin 99, and a link mechanism 14b at the second stage may be constituted by the third transmission link member 96, the fourth link pin 98, the first transmission link member 94, the first link pin 87 and the connection link member 81.

In the link mechanism 14a at the first stage, the rotation radius A1 of the third transmission link member 96 may be larger than the rotation radius B1 of the drive-side rotational portion 82. The rotation radius A1 of the third transmission link member 96 may correspond to the distance between the support pin 99, which is the rotation center of the third transmission link member 96, and the third link pin 97. The rotation radius 131 of the drive-side rotational portion 82 may correspond to the distance between the axis of the casing 32, which is the rotation center of the drive-side rotational portion 82, that is, the axis of the carrier 33 and the second link pin 88.

Further, in the link mechanism 14b at the second stage, the rotation radius A2 of the connection link member 81 may be larger than the rotation radius B2 of the third transmission link member 96. The rotation radius A2 of the connection link member 81 may correspond to the distance between the axis of the support shaft 4, which is the rotation center of the connection link member 81, and the first link pin 87. The rotation radius B2 of the third transmission link member 96 may correspond to the distance between the support pin 99, which is the rotation center of the third transmission link member 96, and the fourth link pin 98.

With the configuration of the link mechanisms 14a and 14b as described above, when the panel 2 receives the wind and a rotational moment occurs in the support shaft 4, the load applied to the drive source 27 (the speed reducer 30) via the transmission mechanism 14 can be reduced in the link mechanism 14b at the second stage in accordance with the ratio between the rotation radius A2 and the rotation radius B2, and the load can be further reduced in the link mechanism 14a at the first stage in accordance with the ratio between the rotation radius A1 and the rotation radius B1. Therefore, it is possible to further reduce the load applied to the drive source 27 (the speed reducer 30).

In addition, the transmission mechanism of the present invention is not necessarily limited to those using a link mechanism. For example, a transmission mechanism including a gear device, a transmission mechanism including a pulley and a timing belt, and the like may be used as the transmission mechanism of the present invention.

In a transmission mechanism using a gear device, for example, a first gear may be coaxially provided on the support shaft of the panel structure, a second gear may be coaxially provided on the carrier or the casing of the speed reducer, and an intermediate gear may be engaged with both the first gear and the second gear. In this arrangement, a drive force may be transmitted from the second gear via the intermediate gear to the first gear and applied from the first gear to the support shaft, whereby the panel structure may be rotationally driven.

In a transmission mechanism including pulleys and a timing belt, for example, a first pulley may be coaxially provided on the support shaft of the panel structure, a second pulley may be coaxially provided on the carrier or the casing of the speed reducer, and a timing belt may be stretched round the first and second pulleys. In this arrangement, the drive force may be transmitted from the second pulley via the timing belt to the first pulley and applied from the first pulley to the support shaft, whereby the panel structure may be rotationally driven.

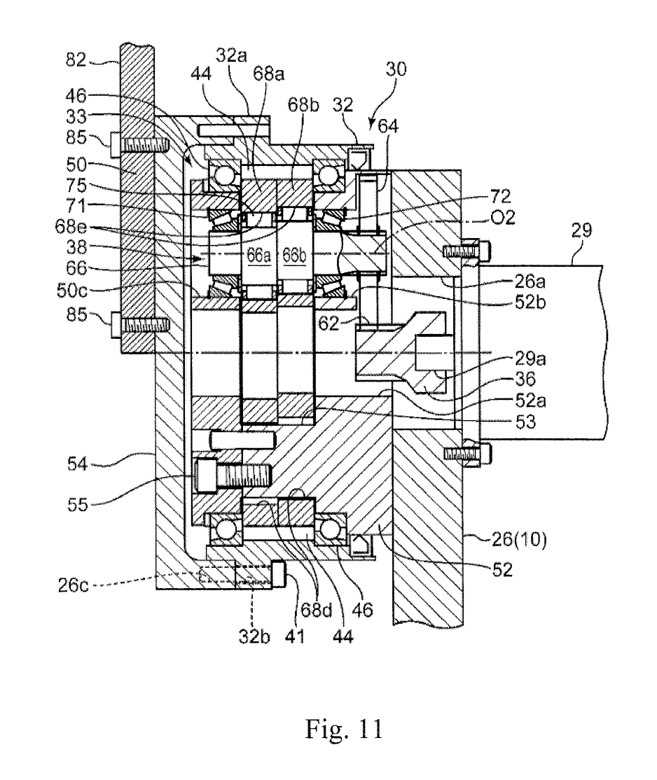

In the above embodiment, the casing 32 of the speed reducer 30 may be fixed, the carrier 33 may rotate with respect to the fixed casing 32, and the drive-side rotational portion 82 may be coupled to the carrier 33. In other words, the casing 32 may serve as a fixed portion, and the carrier 33 may serve as a rotational portion of the speed reducer 30. Alternatively, in the above-described embodiment, it may also be possible that the carrier 33 is fixed, the casing 32 is rotated with respect to the fixed carrier 33, the drive-side rotational portion 82 is coupled to the casing 32, and the link member of the transmission mechanism 14 may be connected via the drive-side rotational portion 82. In other words, the carrier 33 may serve as a fixed portion, and the casing 32 may serve as a rotational portion of the speed reducer 30. An arrangement of such a variation is shown in FIG. 11. In the variation shown in FIG. 11, elements denoted by the same reference numerals as those in the above embodiment correspond to the elements of the above embodiment denoted by the same reference numerals.

Also, it may also be possible that the speed reducer includes only one oscillating gear or three or more oscillating gears. In this case, the crankshaft may include a number of eccentric portions in accordance with the number of oscillating gears.

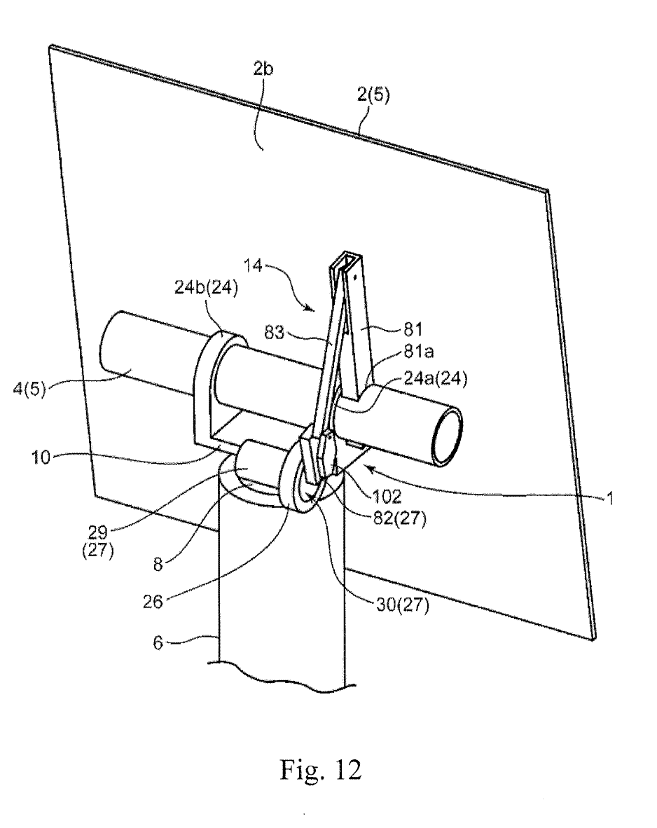

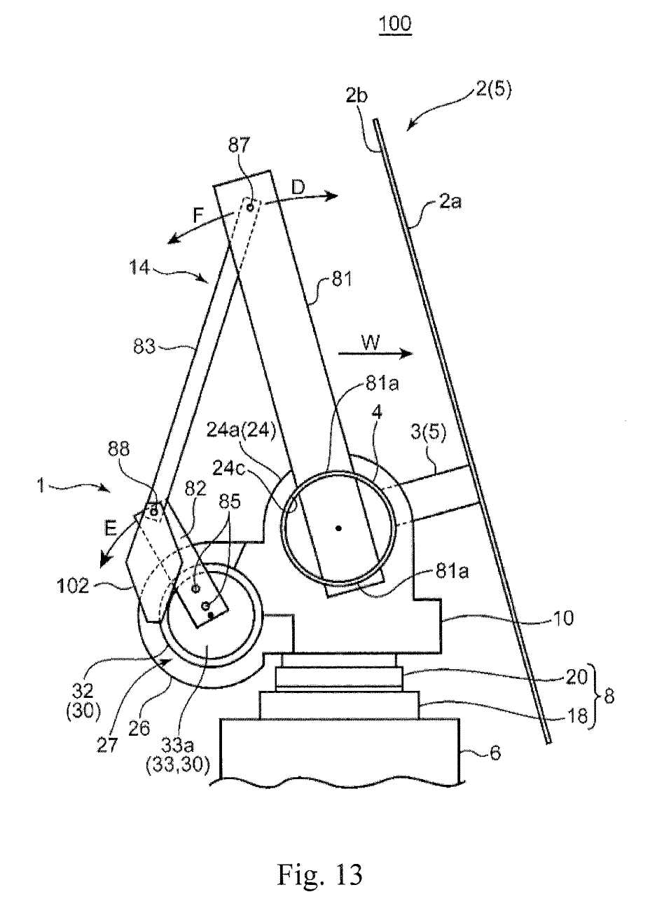

As shown in FIGS. 12 and 13, the panel driving device 1 may also include a counterweight 102 that is attached to the transmission mechanism 14 (the link mechanism) and configured to adjust the load balance related to the rotation of the panel structure 5 about the horizontal axis. The counterweight 102 may apply a load to the link mechanism. The load

may be resistant to rotation of the panel structure 5 about the horizontal axis in the direction in which the panel 2 erects, while the load is assistive to rotation of the panel structure 5 about the horizontal axis in the direction in which the panel 2 levels.

More specifically, the counter weight 102 may be attached so as to be rotatable about the second link pin 88 relative to the second link pin 88. When the drive-side rotational portion 82 rotates and the transmission link member 83 moves, the counterweight 102 may rotate about the second link pin 88 relative to the drive-side rotational portion 82 and the transmission link member 83 so as to maintain the position shown in FIG. 13. That is, the counterweight 102 may keep its center of gravity positioned vertically below the second link pin 88 supporting the counterweight 102.

As shown in FIG. 13, when the wind W blows the back surface 2b of the panel 2, the panel 2 may receive a force in a direction to increase the tilt angle of the panel 2 with respect to the horizontal plane, that is, a force in a direction to erect the panels. In this case, the panel structure 5 and the connection link member 81 may receive a force to rotate them in the direction D shown in FIG. 13. At this time, the load of the counterweight 102 acts as a resistance force for preventing the connection link member 81 from rotating in the direction D via the second link pin 88, the transmission link member 83, and the first link pin 87. Therefore, unintentional rotation of the panel 2 about the horizontal axis in the direction to erect may be suppressed.

On the other hand, when the motor 29 and the speed reducer 30 rotate the drive-side rotational portion 82 in the direction E shown in FIG. 13 to rotate the panel structure 5 in the direction F in order to reduce the tilt angle of the panel 2 with respect to the horizontal plane, the load of the counterweight 102 may act as a force for assisting the rotation of the drive-side rotational portion 82 in the direction E, That is, the load of the counterweight 102 may act as a force for assisting the rotation of the panel structure 5 in the direction F. The weight of the panel structure 5 and the wind W may act as a load against the rotation of the panel structure 5 in the direction F, and this load may be applied to the motor 29 and the speed reducer 30. As described above, the load of the counterweight 102 acts as a force for assisting the rotation of the panel structure 5, such that the load on the motor 29 and the speed reducer 30 can be reduced.

The counterweight 102 may not necessarily have to be attached to the second link pin 88. For example, the counterweight 102 may be attached to a portion of the drive-side rotational portion 82 located radially outside the speed reducer 30 so as to be relatively rotatable about an axis parallel to the axis of the carrier 33. Further, the counterweight 102 may be attached to the first link pin 87 in the same manner as in the case where the counterweight 102 is attached to the second link pin 88. Further, the counterweight 102 may be attached to the connection link member 81 at a position radially outside the support shaft 4 where it does not interfere with the support shaft 4 so as to be rotatable about an axis parallel to the axis of the support shaft 4 relative to the connection link member 81.

Further, the counterweight 102 may not necessarily need to be attached directly to the attachment site to which the counterweight 102 is attached. For example, the counterweight 102 may be attached to the attachment site via a cord-like member such as a wire.

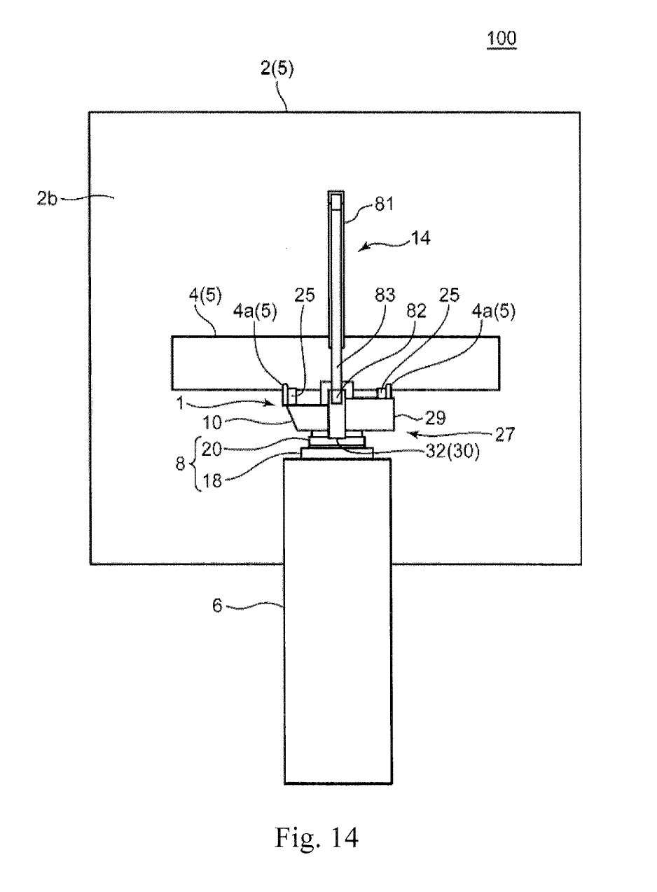

Further, the transmission mechanism 14 may be installed in a position other than those described above. For example, as shown in FIG. 14, the transmission mechanism 14 (the link mechanism) may be installed in such a position that, with respect to the axial direction at the rotation center of the panel structure 5, that is, the axial direction of the support shaft 4, the center of the transmission mechanism 14 (the link mechanism) corresponds to the middle of the width of the panel 2, the middle between the pair of shaft support portions 25, and the axis of the support column 6. With this arrangement, a force for rotating the panel structure 5 about the horizontal axis can be applied from the transmission mechanism 14 (the link mechanism) to the panel structure 5 evenly in the axial direction of the support shaft 4.

Any one of the center of the transmission mechanism 14 (the link mechanism), the middle of the width of the panel 2, the middle between the pair of shaft support portions 25, and the axis of the support column 6 may be offset in the axial direction of the support shaft 4.

The speed reducer used in the present invention is not necessarily limited to the eccentric oscillating speed reducer configured as described above. For example, the speed reducer may be constituted by a known planetary gear reducer. Further, the speed reducer may be constituted by a center-crank eccentric oscillating speed reducer having a crankshaft disposed at a position corresponding to the axis of the casing.

Further, the drive source in the present invention may not necessarily include a speed reducer. That is, the reduction gear may not be interposed between the drive shaft of the motor of the drive source and the drive-side rotational portion. In this case, the drive-side rotational portion may be fixed to the drive shaft of the motor of the drive source,

### Summary of Embodiments

The embodiments described above can be summarized as follows.

A panel driving device according to the embodiments described above is a panel driving device for rotating a panel structure to vary a tilt thereof or turning the panel structure about a vertical axis, the panel structure including a panel for receiving sunlight, the panel driving device comprising; a drive source including a rotational portion capable of rotating; and a transmission mechanism including a connection portion connected to the panel structure, and configured to convert a rotational movement of the rotational portion into rotation or turning of the panel structure without converting the rotational movement of the rotational portion into a linear movement, wherein the connection portion is offset from a rotation axis of the rotational portion.

The panel driving device may include the transmission mechanism that converts the rotational movement of the rotational portion of the drive source into the rotation or turning of the panel structure. The connection portion of the transmission mechanism connected to the panel structure may be offset from the rotation axis of the rotation portion. Therefore, even when a bending moment occurs due to the weight of the panel or the wind blowing the panel, the bending moment can be prevented from being imparted directly to the drive source. Moreover, in this panel driving device, the transmission mechanism may convert the rotational movement of the rotational portion of the drive source into the rotation or turning of the panel structure without converting it into the linear movement, and therefore, unlike the conventional panel driving devices including a direct-acting drive source, there is no problem that the drive source has a large length in the direction of direct-acting thereof. Therefore, the panel driving device can be downsized.

In the panel driving device, it may be preferable that the rotation axis of the rotational portion is parallel to an axis of rotation or turning of the panel structure.

In the panel driving device, it may be preferable that the transmission mechanism includes a panel-side rotational portion configured to rotate integrally with the panel structure and a transmitting portion that transmits operation between the panel-side rotational portion and the rotational portion, and the rotation radius of the panel-side rotational portion is larger than that of the rotational portion.

With this arrangement, when the panel receives the wind and a rotational moment is generated, the load applied to the rotational portion and the drive source via the transmission mechanism can be reduced in accordance with the ratio of the rotation radius between the connection portion and the rotation portion.

In the panel driving device, it may be preferable that the transmission mechanism is constituted by a link mechanism.

With this arrangement, the transmission mechanism is constituted by a link mechanism that is almost maintenance-free, and therefore, the burden of maintenance of the transmission mechanism can be reduced.

In the panel driving device, it may be preferable that the drive source includes a motor and a speed reducer, the motor having a drive shaft and configured to rotate the drive shaft, the speed reducer being configured to reduce a rotation speed of the drive shaft and rotate the rotational portion at the reduced rotation speed, and the speed reducer includes an internal gear and an external gear, the external gear being configured to rotate inside the internal gear while meshing with the internal gear, the speed reducer being configured to reduce the rotation speed of the drive shaft in accordance with a difference in a number of teeth between the internal gear and the external gear.

With this arrangement, the rotation speed of the drive shaft of the motor can be reduced to a desired rotation speed by the speed reducer, and the rotational portion can be rotated at the reduced rotation speed to rotate or turn the panel structure.

In this case, it may be preferable that the speed reducer is an eccentric oscillating speed reducer, the eccentric oscillating speed reducer including a crankshaft, the crankshaft having an eccentric portion engaged with the external gear and configured to rotate because of the rotation of the drive shaft transmitted thereto, and the external gear oscillates eccentrically and rotates in accordance with the rotation of the crankshaft.

In the conventionally known drive unit of the panel driving device including the ball screw, backlash may occur in the ball screw, making it difficult to adjust the rotation angle or the turning angle of the panel with high precision. By contrast, in this arrangement, the eccentric oscillating speed reducer configured as described above may rotate the rotational portion at the reduced rotation speed, and as the rotational portion rotates, the panel structure may be rotated or turned. As a result, the generated backlash is smaller than with the ball screw. Therefore, with this arrangement, it is possible to adjust the rotation angle or the turning angle of the panel with high precision.

In the panel driving device including the speed reducer, it may be preferable that the speed reducer includes a casing provided fixedly,

the rotational portion includes a carrier and a drive-side rotational portion, the carrier being rotatably supported in the casing, the drive-side rotational portion being connected to the transmission mechanism and configured to rotate integrally with the carrier, the carrier includes a projecting portion projecting outward of the casing in a direction of a rotation axis of the carrier, and the drive-side rotational portion extends in a radial direction of the casing at a position on the side where the projecting portion projects from the casing, and is coupled to the projecting portion.

In this arrangement, the drive-side rotational portion coupled to the transmission mechanism may extend in the radial direction of the casing at a position on the side where the projecting portion of the carrier projects from the casing and may be coupled to the projection portion. Therefore, when the reduction gear rotates the carrier about the rotation axis thereof relative to the casing, it can be prevented that the drive-side rotational portion interferes with the casing and the rotation range of the drive-side rotational portion is restricted.

In the arrangement in which the transmission mechanism is a like mechanism, the panel driving device further comprises: a counterweight attached to the link mechanism, wherein the link mechanism is configured to convert the rotational movement of the rotational portion into rotation of the panel structure for varying the tilt of the panel structure, and the counterweight is configured to apply a load to the link mechanism, the load being resistant to the rotation of the panel structure in a direction to erect the panel, while the load being assistive to the rotation of the panel structure in a direction to level the panel.

In this arrangement, when the wind blows the panel in a direction to erect the panel, the panel structure may rotate about the horizontal axis in a direction in which the panel structure erects. At this time, the load applied to the link mechanism by the counterweight may act as a resistance force, and therefore, unintentional rotation of the panel structure in the direction in which the panel erects can be suppressed. In the case where, when the wind is blowing the panel in a direction to erect the panel, the panel structure is rotated about the horizontal axis in a direction to level the panel, the load applied to the link mechanism by the counterweight may act as a force assisting the rotation of the panel structure. In this case, it is possible to reduce the load on the drive source for the rotation of the panel structure in the direction to level the panel.

In addition, the heliostat according to the above-described embodiment may include a support column erected at a desired place, a panel structure having a panel made of a mirror receiving and reflecting the sunlight and supported at an upper end of the support column, and the panel driving device.

This heliostat may provide the same advantages as the panel driving device,

As described above, according to the embodiment, it may be possible to prevent a bending moment from being imparted directly to a driving portion of the panel driving device for rotating the panel structure, and to downsize the panel driving device.

The panel driving device according to the above embodiment may be configured to rotationally drive a panel and may include a rotational driving portion that rotates a rotational portion offset from the rotation axis of the panel, and a transmission means for receiving the rotation of the rotational portion and rotating the panel about the rotation axis.

1. A panel driving device for rotating a panel structure to vary a tilt thereof or turning the panel structure about a vertical axis, the panel structure including a panel for receiving sunlight, the panel driving device comprising:
a drive source including a rotational portion capable of rotating; and
a transmission mechanism including a connection portion connected to the panel structure, and configured to convert a rotational movement of the rotational portion into rotation or turning of the panel structure without converting the rotational movement of the rotational portion into a linear movement,
wherein the connection portion is offset from a rotation axis of the rotational portion.

2. The panel driving device of claim 1, wherein the rotation axis of the rotational portion is parallel to an axis of rotation or turning of the panel structure.

3. The panel driving device of claim 1, wherein
the transmission mechanism includes a panel-side rotational portion configured to rotate integrally with the panel structure and a transmitting portion configured to transmit operation between the panel-side rotational portion and the rotational portion, and
a rotation radius of the panel-side rotational portion is larger than a rotation radius of the rotational portion.

4. The panel driving device of claim 1, wherein the transmission mechanism is a link mechanism.

5. The panel driving device of claim 1, wherein
the drive source includes a motor and a speed reducer, the motor having a drive shaft and configured to rotate the drive shaft, the speed reducer being configured to reduce a rotation speed of the drive shaft and rotate the rotational portion at the reduced rotation speed, and
the speed reducer includes an internal gear and an external gear, the external gear being configured to rotate inside the internal gear while meshing with the internal gear, the speed reducer being configured to reduce the rotation speed of the drive shaft in accordance with a difference in a number of teeth between the internal gear and the external gear.

6. The panel driving device of claim 5, wherein the speed reducer is an eccentric oscillating speed reducer, the eccentric oscillating speed reducer including a crankshaft, the crankshaft having an eccentric portion engaged with the external gear and configured to rotate because of the rotation of the drive shaft transmitted thereto, and the external gear oscillates eccentrically and rotates in accordance with the rotation of the crankshaft.

7. The panel driving device of claim 5, wherein
the speed reducer includes a casing provided fixedly,
the rotational portion includes a carrier and a drive-side rotational portion, the carrier being rotatably supported in the casing, the drive-side rotational portion being connected to the transmission mechanism and configured to rotate integrally with the carrier,
the carrier includes a projecting portion projecting outward of the casing in a direction of a rotation axis of the carrier, and
the drive-side rotational portion extends in a radial direction of the casing at a position on the side where the projecting portion projects from the casing, and is coupled to the projecting portion.

8. The panel driving device of claim 4, further comprising:
a counterweight attached to the link mechanism,
wherein the link mechanism is configured to convert the rotational movement of the rotational portion into rotation of the panel structure for varying the tilt of the panel structure, and
the counterweight is configured to apply a load to the link mechanism, the load being resistant to the rotation of the panel structure in a direction to erect the panel, while the load being assistive to the rotation of the panel structure in a direction to level the panel.

9. A heliostat comprising:
a support column erected at a desired place;
a panel structure having a panel made of a mirror receiving and reflecting sunlight and supported at an upper end of the support column; and
the panel driving device of claim 1.
